(19) United States
(12) Patent Application Publication
(10) Pub. No.: US 2010/0066509 A1
(43) Pub. Date: Mar. 18, 2010

(54) INCLUSION MANAGING DEVICE, MANUFACTURING APPARATUS OF INCLUSION MANAGING DEVICE, MANUFACTURING METHOD OF INCLUSION MANAGING DEVICE, AND INCLUSION MANAGING METHOD

(75) Inventors: Seiji Okuizumi, Tokyo (JP); Kenichi Kamijo, Tokyo (JP)

Correspondence Address: FOLEY AND LARDNER LLP;SUITE 500, 3000 K STREET NW, WASHINGTON, DC, 20007, US

(73) Assignee: NEC Corporation

(21) Appl. No.: 12/450,445

(22) PCT Filed: Jan. 8, 2008
(86) PCT No.: PCT/JP2008/050062

§ 371 Date: Nov. 9, 2009

(30) Foreign Application Priority Data
Mar. 27, 2007 (JP) 2007-084702

(51) Int. Cl. G06Q 50/00; G08C 19/00; G06K 19/06

(52) U.S. Cl. 340/10.5; 235/494; 235/385; 235/492

(57) ABSTRACT

Whether a patient actually takes medicine or not is traced and recorded. The used state of a packaged object is traced and recorded. Specifically, a passive wireless tag and an antenna are attached to a packaged object management device. The passive wireless tag is disposed on the package containing a packaged object, and power is generated in the passive wireless tag by electromagnetic induction (contactless power transmission) through a radio wave from a reader, and the passive wireless tag receives/transmits a radio wave to transmit/receive information. The antenna is disposed in a region (take-out opening) for taking out the packaged object from the package so that the antenna can be broken when the packaged object is taken out and is used to inform the passive wireless tag of the take-out of the packaged object. The gap between the boundary of the region (take-out opening) for taking out the packaged object and the antenna is smaller than the minimum width large enough to take out the packaged object.

### TECHNICAL FIELD

The present invention relates to an inclusion managing device, and more particularly relates to an inclusion managing device for obtaining a state of ingestion of medicines and foods. This application is based upon and claims the benefit of priority from Japanese Patent Application No. 2007-084702, and the disclosure of Japanese Patent Application No. 2007-084702 is incorporated herein in its entirely by reference.

### BACKGROUND ART

By referring to electronic medical records, it is possible to retroactively manage medicines prescribed to a patient by doctors. However, there is no means for managing whether or not the patient actually takes the prescribed medicines. Thus, it is difficult to accurately derive a relation between effects of dosage and treatment in a medical care. For example, there is a case that, although the patient himself does not want to take medicines, the patient cannot sufficiently inform a doctor of his intention. In this case, dosage and treatment are repeated in vain.

Also, since large managing apparatus or a large system is required to manage medicine taking, it is impossible to manage information with respect to outpatients for whom the management is primarily demanded.

However, in recent years, in association with advance and miniaturization of RF-ID (Radio Frequency Identification) tags, methods are considered which manage medicine taking by using the RF-ID tags in various ways.

As related art, Japanese Utility Model Registration No. 3128634 discloses a packed agent provided with an RFID tag (Radio Frequency Identification tag). This related art provide a packed agent provided with a small RFID tag and an antenna connected to the RFID tag.

Also, Japanese Laid Open Patent Application (JP-P 2005-013488A) discloses a medicine storage tool and a medicine-taking management system using the tool. This related art provide a package to which an RF-ID tag and an antenna are attached.

Also, Japanese Laid Open Patent Application (JP-P 2006-059072A) discloses a mail system with an RFID tag, which has a function of reporting an opening. In this related art, an effective length of an antenna is set to a length suitable for receiving radio wave transmitted by an RFID reader.

Also, Japanese Laid Open Patent Application (JP-P 2006-203637A) discloses a wireless tag and an article managing method that uses a wireless tag. According to the related art, a corresponding frequency band of an antenna is changed. Also, the wireless tag has an antenna portion including a fixed portion and a resectable portion.

Also, Japanese Laid Open Patent Application (JP-P 2006-259939A) discloses a medicine managing system. According to the related art, a user connects a mobile terminal through a wired line or the like to a first aid box with an asking unit for RF-ID tag. The first aid box contains a medicine with a RF-ID tag and a user ID card with a RF-ID tag which records user information. The mobile terminal, after automatically recognizing the medicine with the RF-ID tag and the user ID card with the RF-ID tag contained in the medicine box with the asking unit for RF-ID tag, transmits results of the automatic recognition to a server system.

Also, Japanese Laid Open Patent Application (JP-P 2004-503271A) discloses an agent delivery managing system. According to the related art, the system for managing delivery of pharmaceutical agent includes a blister package that has a plurality of cells arranged in the lattice. Respective cells are sealed by breakable walls and resectable conductor wires respectively placed at the closest positions to the breakable walls. A computer chip detects formations of holes in the respective cells arranged in the lattice by respectively monitoring breaks in the conductive wires. An RF transmitter is coupled to the computer chip and transmits information with regard to states of use of respective agents stored in the blister package to a remote transceiver.

### DISCLOSURE OF INVENTION

An object of the present invention is to provide an inclusion managing device which can detect remove of an inclusion packed in a package by checking a state of a member arranged on the package.

An inclusion managing device according to the present invention includes a passive type wireless tag (passive tag) and an antenna. The passive type wireless tag is arranged on a package for packing an inclusion, generates a voltage through electromagnetic induction (contactless power transmission) caused by radio wave from a reader, and transmits/receives information by emitting/receiving radio wave. The antenna is arranged at a region for removing the inclusion (ejection port) on the package such that the antenna is broken at remove of the inclusion from the package and notifies the passive type wireless tag of the remove of the inclusion. A gap between the antenna and a border of the region for removing the inclusion (ejection port) is smaller than the minimum width required to remove the inclusion.

Another inclusion managing device according to the present invention includes packages for packing inclusions and two-dimensional barcodes. The two-dimensional barcodes correspond to inclusions in one-to-one relation, include information with regard to the inclusions, are displayed to cover regions for removing the inclusions (ejection ports) on the packages and are loss at remove of the inclusions from the packages.

Still another inclusion managing device according to the present invention includes packages for packing inclusions and two-dimensional barcodes. The two-dimensional barcodes correspond to inclusions in one-to-one relation, include information with regard to the inclusions, are displayed in the packages such that the two-dimensional barcodes are concealed by the inclusions, and become recognizable when the inclusions are removed from the packages.

A manufacturing apparatus of an inclusion managing device according to the present invention includes a wireless tag install unit and an antenna install unit. The wireless tag install unit arrange a passive type wireless tag, which generates a voltage through electromagnetic induction (contact less power transmission) caused by radio wave from a reader and transmits/receives information by emitting/receiving radio wave, on a package for packing an inclusion. The antenna install unit arrange an antenna, which is broken at remove of the inclusion from the package and notifies the passive type wireless tag of remove of the inclusion, at a region for removing the inclusion (ejection port) on the package such that a gap between the antenna and a border of the region for removing the inclusion (ejection port) is smaller than minimum width required to remove the inclusion.

Another manufacturing apparatus of an inclusion managing device according to the present invention includes a packing unit for packing inclusions in packages and a barcode install unit. The barcode install unit displays two-dimensional barcodes such that the two-dimensional barcodes cover regions for removing the inclusions (ejection ports) on the packages. The two-dimensional barcodes include information with regard to the inclusions and correspond to the inclusions in one-to-one relation.

Still another manufacturing apparatus of an inclusion managing device according to the present invention includes a packing unit for packing inclusions in packages and a barcode install unit. The barcode install unit display two-dimensional barcodes such that the two-dimensional barcodes are concealed by the inclusions in the packages and become recognizable when the inclusions are removed from the packages. The two-dimensional barcodes include information with regard to the inclusions and correspond to the inclusions in one-to-one relation.

In this way, it is attained that a manager for managing things in the inclusion managing device traces and records whether or not the user actually carries out opening and using.

### BRIEF DESCRIPTION OF DRAWINGS

FIG. 1 shows an example of an inclusion managing device (package) according to the present invention;

FIG. 2 shows a first example of a shape of antenna;

FIG. 3 shows a second example of a shape of antenna;

FIG. 4 shows a third example of a shape of antenna;

FIG. 5 is a schematic diagram showing a configuration of a first inclusion managing system according to the present invention;

FIG. 6 is a flowchart showing operations when a state of use of inclusion is managed;

FIG. 7 is a flowchart showing operations when use of the inclusion is supported;

FIG. 8 is a flowchart showing operations when a number of inclusions to be used in the next time is calculated;

FIG. 9 is a sequence diagram showing data flows in the inclusion managing system;

FIG. 10 is a schematic diagram showing a configuration of a second inclusion managing system according to the present invention; and

FIG. 11 is a block diagram showing a configuration of a packing apparatus (manufacturing apparatus).

### BEST MODE FOR CARRYING OUT THE INVENTION

A first exemplary embodiment of the present invention will be described below with reference to the attached drawings.

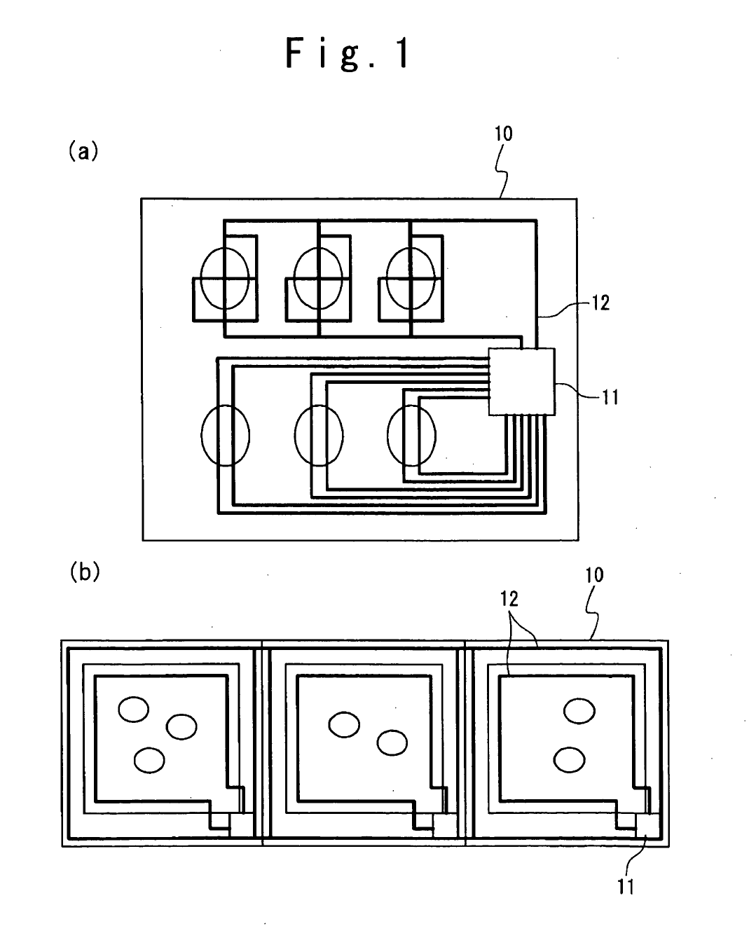

FIG. 1 shows a detailed example of a packing method. Here, (a) a medicine taking management RF-ID tag for a medicine PTP (Press Through Package) sheet and (b) a medicine taking management RF-ID tag for a medicine packing bag are indicated as examples.

As shown in FIG. 1, an inclusion managing device 10 according to the present invention includes a wireless tag 11 and an antenna 12.

The inclusion managing device 10 is a package of inclusions such as medicines or foods, which enables management of ingestion of the inclusions at low cost by using RF-ID. The RF-ID can record therein manufacturing dates of agents or foods, inclusion detailed-information, manufacturer information, preservation record and the like, in a read-only state or in a readable/writable state. By the way, the agents or the food is assumed to include not only medicines but also condiment, confectionery, supplements and the like.

Features of this package are as follows.

(1) A plurality of tablets can be managed by one chip.
(2) Whether or not a package is separated can be managed.
(3) A number of packages connected side by side can be managed.

The wireless tag 11 is a passive type RF-ID tag (passive tag) which generates a voltage by electromagnetic induction (contactless power transmission). The passive type RF-ID tag has no power source and uses electromagnetic induction caused by radio wave emitted from an antenna of an RF-ID reader/writer. Therefore, the passive type RF-ID tag is small and low price, has no risk of exhaustion of electric power, and is suitable for use in a home (outpatient) in general, as compared with an active type RF-ID tag. The wireless tag 11 is preferred to have an ID (Identification Information) specific to the inclusion managing device 10 (package). The ID (Identification Information) may include an ID (Identification Information) of a patient who takes the packed inclusion. In this case, it is possible to know which user (patient) uses (takes) which inclusion (agent or food).

The antenna 12 is electrically connected to the wireless tag 11 and extends along a surface or a periphery of the package in order to check whether the packed inclusion is removed. Here, the antenna 12 may be arranged on the inner side of a cover with which the inclusions are packed. The antenna 12 is arranged at least in a region to be opened (an ejection port) of the package. The wireless tag 11 specifies a place from which the inclusion is ejected based on a change in frequency corresponding to a change in an effective length of the antenna 12 that results from a break or the like. When the ejection of the inclusion is checked, it is difficult to judge that the package is intentionally opened based on only a break of the cover with which the inclusion is packet. Thus, it is important to set a shape and width (range) of the antenna correspondingly to a size and shape of the inclusion. The antenna 12 is, for example, cross-shaped, X-letter-shaped, lattice-shaped or the like. However, the antenna 12 is not limited to these examples. For example, the antenna 12 is considered to be arranged as a pattern or decoration of the package, or arranged in a shape that resembles a drawing of a character or a logotype of an enterprise. Also, in order to ensure that the inclusion cannot be ejected without breaking the antenna 12, a gap between the to-be-opened region (ejection port) of the package and the antenna 12 is required to be smaller than the minimum width which allows the inclusion to be ejected. A gap between antennas 12 arranged in the same to-be-opened region (ejection port) is similarly set. In this way, by selecting the shape, arrangement, width, material and the like of the antenna 12, it is possible to discriminate the break and the ejection of the inclusion.

The antenna 12 is not limited to an electrically single antenna which is arranged to cover all the inclusions, as shown in a top portion (a) of FIG. 1. For example, as shown in a bottom portion (a) of FIG. 1, respective independent antennas 12 may be arranged to correspond to the inclusions in one-to-one relation. In this case, the respective independent antennas 12 respectively correspond frequencies different from each other.

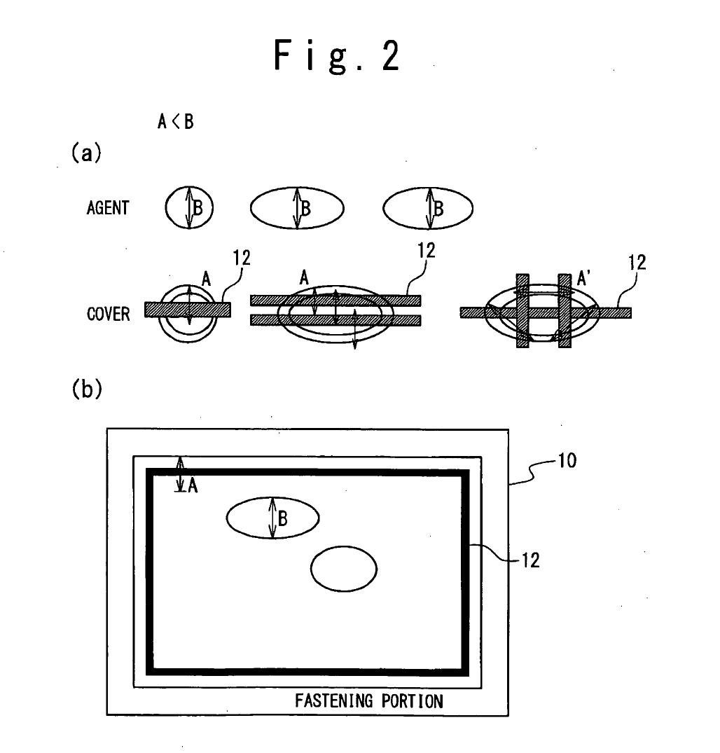

FIG. 2 shows a first example of the shape of the antenna 12.

Here; a case is described in which the inclusions are solids such as pills or capsules.

In order to check the ejection of the inclusion and the like, it is required to detect that the cover packing the inclusion is intentionally broken. By setting in detail the shape of the antenna 12 corresponding to the size and shape of the inclusion and the width (range) of wiring of the antenna 12, it is possible to prevent the cover from being unintentionally broken, and it is possible to judge that the cover is intentionally broken when the cover is broken. Actually, as shown in (a), the antenna 12 is arranged such that a length A of the ejection port including the antenna 12 is shorter than a minor diameter B of the inclusion sealed in the PTP. Also, as shown in (b), in the case of the drug bag in which a plurality of agents can be included, the antenna 12 is arranged on the inner side of a fastening portion for sealing the drug bag, and the smallest agent is a target. In this case, with respect to a minor diameter B of the smallest agent, the antenna 12 is arranged inside the fastening portion, along the fastening portion, in the range within the length A from the fastening portion. That is, the antenna 12 is arranged such that A is smaller than B.

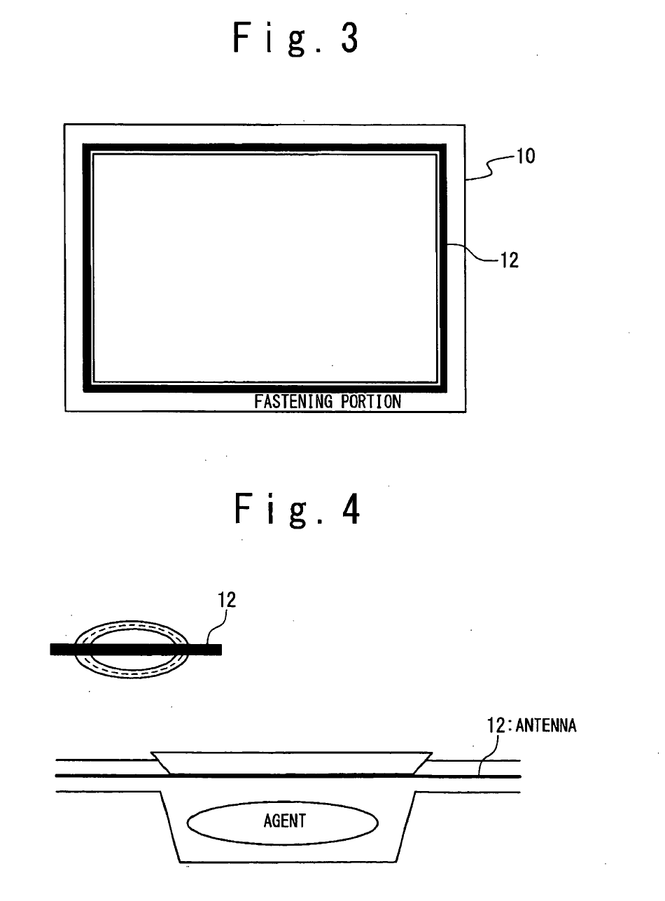

FIG. 3 shows a second example of the shape of the antenna 12.

Here, a case is described in which the inclusion is powder, liquid, viscous material, or agent such as perfume or fragrance agent, which includes smelled gas. In this case, there is a possibility that the inclusion is ejected even when the drug bag that packs those is slightly opened. Thus, the antenna 12 is arranged in the fastening portion closely to the inside. For example, the antenna 12 is preferred to be arranged on a boundary between the fastening portion and the inside or along the boundary.

FIG. 4 shows a third example of the shape of the antenna 12.

When the broken antenna 12 is again joined, the antenna 12 becomes in a state electrically equal to the state before the break. Thus, there is a possibility that the antenna 12 is recognized not to be broken by mistake. So, in order to prevent the broken antenna 12 from being again joined, perforations are formed along the ejection port. Or, by using a rigid element such as a lid as an element covering the ejection port (cover), a mechanism is provided in which the entire lid is removed from the package such that the removed lid cannot be recovered. In this case, the lid adheres to the antenna 12 such that the antenna 12 is removed when the lid is opened. Or, a mechanism is considered in which the lid and the antenna 12 are broken at the same time when the lid is opened. In this case, a portion of the antenna 12 is preferred to be lost at the opening.

Also, in the inclusion managing device 10 (package), an antenna may be provided in addition to the packed agents or foods such that the antenna indicates a refusal by the patient to take the medicines when the antenna is broken. For example, a dummy packing region in which the medicine is not packed is provided, and it is judged that the patient refuses to take the medicines when an antenna arranged in the dummy packing region is broken. Thus, the intention of the patient can be transmitted more certainly.

In this way, when the plurality of medicines or foods are packed as one unit, ejection status of the plurality of inclusions can be managed by one RF-ID by arranging antennas, electrical circuits or the like of the RF-ID for respective packs. By selecting the shape, arrangement, width, material and the like of the antenna, it is possible to discriminate the break and the ejection of the inclusion.

For example, when one antenna is cut by the ejection of the inclusion such as medicine or food, a place from which the inclusion is ejected is specified based on transmission and reception of radio wave of a frequency set correspondingly to the length of the broken antenna.

Moreover, by selecting the shape, arrangement, width and material of the antenna, it is possible to arrange the antenna as a pattern or decoration of the inclusion managing device 10 (package). For example, the antenna is considered to be arranged in a shape that resembles a drawing of a character or a logotype of an enterprise.

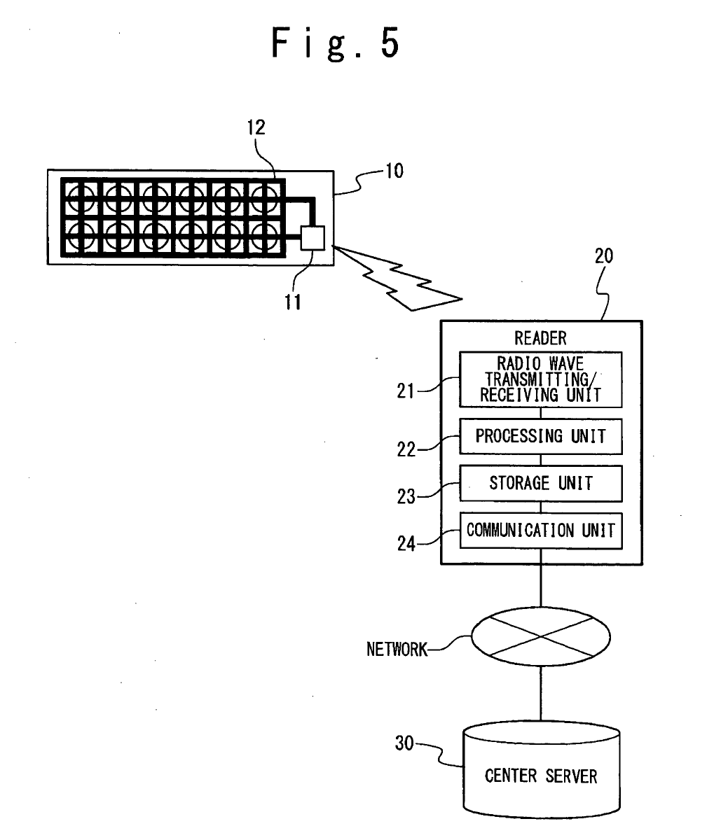

Next, an inclusion managing system using the inclusion managing device 10 will be described. As shown in FIG. 5, the inclusion managing system according to the present invention includes the inclusion managing device 10, a reader 20 and a center server 30. The inclusion managing device 10 is as described above.

The reader 20 emits radio wave such that the wireless tag 11 on the inclusion managing device 10 generates a voltage by electromagnetic induction (contactless power transmission). Also, the reader 20 transmits and receives information to and from the wireless tag by transmitting and receiving radio wave. For example, the reader 20, when specifying the place from which the inclusion is ejected based on the effective length of the cut antenna 12, transmits and receives radio wave of the frequency set correspondingly to the effective length. The effective length and the frequency are assumed to be correlated each other. Here, in a case that the wireless tag 11 holds effective frequency information corresponding to the cut antenna 12, reading and writing are possible by one reader 20 even when another ID tag exists. That is, the reader 20 transmits and receives radio wave of the frequency corresponding to the effective length to and from the wireless tag 11. The reader 20 can identify the wireless tag 11 based on the effective length or the frequency. Here, an RF-ID reader/writer is assumed to be the reader 20.

The center server 30 communicates through a network or the like with the reader 20 and collectively manages the information provided by the reader 20.

Next, an example of information transmitted and received between the wireless tag 11 on the inclusion managing device 10 and the reader 20 is described below in detail, which is other than the information with respect to the ejection of the inclusion based on the break of the antenna 12. Between the wireless tag 11 and the reader 20, transmitted and received is at least one piece of information among pieces of information indicated in (1)-(11) as follows. Amount of information can be transmitted and received is limited by storage size of the wireless tag 11. However, when the storage size of the wireless tag 11 is large enough, all the pieces of information can be transmitted and received.

(1) <Medicine Information Such as Name, Product Number, Manufacturing Date, Expiration Date, Production Lot, Individual ID>

These are pieces of information indicating names, product number, expiration date, production lot, individual ID and the like of the inclusion (for example, medicine) packed in the inclusion managing device 10. Based on these pieces of information, it is possible to know the kind of the inclusion to be used by the user (for example, the medicine to be taken by the patient) and manage the expiration date of the inclusion.

(2) <Patient Information Such as Patient ID and Medical Record Number>

These are identification information indicating the user (for example, the patient) who uses the inclusion (for example, the medicine) packed in the inclusion managing device 10, and personal information of the user. Based on these pieces of information, it is possible to know a user who uses the inclusion and manage a result of use of the inclusion by the user.

(3) <Manufacturer Information Such as Hospital ID, Doctor ID and Pharmacist ID>

These are pieces of identification information that indicate a manufacturer or a provider of the inclusion managing device 10 and a manufacturer or a provider of the inclusion packed in the inclusion managing device 10. Based on these pieces of information, it is possible to manage a person who manufactures or provides the inclusion managing device 10 or the inclusion.

(4) <Disease Information Such as Disease Name of Patient and Treatment Method>

These are pieces of information indicating a reason for which the user (for example, the patient) using the inclusion (for example, the medicine) packed in the inclusion managing device 10 uses the inclusion. Based on these pieces of information, it is possible to judge whether or not the use of the inclusion by the user is proper. Also, it is possible to point out how to use the inclusion.

(5) <Past Medicine-Taking History>

These are pieces of information indicating a history of use of the inclusion by the user (for example, the patient) who uses the inclusion (for example, the medicine) packed in the inclusion managing device 10. Based on the pieces of information, it is possible to know a number of times the user uses the inclusion and a result (an effect) of the use, and thus to judge whether or not the future use of the inclusion by the user is proper.

(6) <History of Past Disease, Hospital Visit and Hospitalization>

These are pieces of information that indicates a state of the user (for example, the patient) using the inclusion (for example, the medicine) packed in the inclusion managing device 10, and prerequisites to the use of the inclusion. Based on these pieces of information, it is possible to limit the use of the inclusion by the user and to provide a proper using method.

(7) <Information with Regard to Medicine Taking Method Such as Usage and Adverse Reaction>

These are pieces of information that indicates a secondary effect or an influence caused by the use of the inclusion by the user (for example, the patient) using the inclusion (for example, the medicine) packed in the inclusion managing device 10 or another user, or a possibility of occurrence of the secondary effect or the influence. Based on these pieces of information, it is possible to avoid a disadvantage caused by the use of the inclusion by the user.

(8) <Information or Output Data for Measuring Equipment that Can Judge Whether or Not Ingestion is Necessary>

These are pieces of information or output data that are provided to measuring equipment (for example, a blood pressure gauge and a blood glucose level meter) when the measuring equipment detects the inclusion (for example, the medicine) packed in the inclusion managing device 10 by approaching or contacting the inclusion managing device 10. Based on these pieces of information, it is possible to judge whether or not the user (for example, the patient) is required to use the inclusion (for example, the medicine) when the measuring equipment approaches or contacts the inclusion managing device 10.

(9) <Record of Bringing-Out from Storage Place and Record of Carrying into Medicine Cabinet or House of Patient>

These are pieces of information indicating that the inclusion (for example, the medicine) packed in the inclusion managing device 10 is brought out from a predetermined place or carried into a predetermined place. Here, the reader 20 is preferred to be installed in the vicinity of an entrance gate (entrance) of the predetermined place or the vicinity of an installation place of the inclusion. Based on these pieces of information, it is possible to manage a state of migration or a state of storage of the inclusion packed in the inclusion managing device 10.

(10) <Record of Installation to Specific Medicine-Taking Assist Apparatus or Measuring Equipment>

These are pieces of information indicating a history of obtainment or detection of the inclusion by medicine-taking assist apparatus (for example, inhalator, syringe and drip infusion device) or measuring equipment, which obtains or detects the inclusion (for example, the medicine) packed in the inclusion managing device 10 by approaching or contacting the inclusion managing device 10. Based on these pieces of information, it is possible to know a number of times of obtainment or detection of the inclusion by the medicine-taking assist apparatus or the measuring equipment.

(11) <Electronic Certification for Preventing Invalid Medicine>

These are electronic certifications or pieces of information similar to the electronic certifications, which indicate that the inclusion (for example, the medicine) packed in the inclusion managing device 10 is a valid (genuine) inclusion. Based on these pieces of information, it is possible to confirm that the inclusion packed in the inclusion managing device 10 is the valid inclusion for which quality is insured.

By the way, the reader 20 transmits the above-described information to the center server 30. Here, when the patient rejects to take the packed agent or food, the reader 20 may receive an input of information such as a fact that the patient rejects the medicine taking, a reason of the rejection or comment and transmit the input information together with above-described information to the center server 30.

Examples of the reader 20 are as follows. However, actually, the reader 20 is not limited to these examples. Here, explanations will be given respectively for a case of home and a case of hospital or pharmacy.

In the case of home, the followings are considered as examples of the reader 20.

(1) A reader connected to a personal computer as a peripheral device
(2) A handy terminal or a mobile telephone capable of reading the wireless tag
(3) A reader attached to a periphery of a door of a room, a ceiling or a table
(4) A reader attached to a medicine cabinet or a refrigerator for storing the package
(5) A reader attached to a tray on which the package is mounted
(6) A reader attached to a handset or a main body of a landline telephone

In the case of hospital or pharmacy, the followings are considered as examples of the reader 20.

(1) Apparatus or equipment for assisting medicine taking, such as syringe, inhalator and drip infusion device
(2) Apparatus or equipment for displaying an index of health or medicine taking, such as blood pressure gauge and blood glucose level meter
(3) An automatic packaging device for automatically forming drug bags or the like
(4) A prescription check terminal in a pharmacy
(5) A terminal for managing medical history or drug history in a hospital, a pharmacy or a home
(6) An accounting terminal and apparatus for managing enter/exit into/from a hospital or a pharmacy
(7) Medicine manufacturing apparatus and packing apparatus
(8) Apparatus, measuring equipment, or a terminal for quality control of medicine

By the way, when a user unfamiliar with operation of the apparatus or the equipment is took into consideration, it is preferred that the reader is installed or a reading function based on a circuit, a program or the like is added in a place at/through which the user stops/passes at a high probability or in a tool having a high probability of being used by the user. Also, preferably, there is provided a configuration capable of reading based on a natural (usual) operation without special operation for reading.

Here, the reader 20 contains a radio wave transmitting/receiving unit 21, a processing unit 22, a storage unit 23 and a communication unit 24.

The radio wave transmitting/receiving unit 21 emits radio wave to cause the wireless tag 11 on the inclusion managing device 10 to generate a voltage through electromagnetic induction (contactless power, transmission). Also, the radio wave transmitting/receiving unit 21 receives and transmits information from and to the wireless tag 11 by receiving and emitting radio wave. Here, the radio wave transmitting/receiving unit 21 is assumed to be a reader/writer antenna. However, actually, the radio wave transmitting/receiving unit 21 is not limited to the reader/writer antenna. The processing unit 22 obtains information through the radio wave transmitting/receiving unit 21 from the wireless tag 11. At this time, the processing unit 22 may record the date when the information is obtained, by using a timer function. Consequently, the date when the medicine is removed can be known to some extent. The storage unit 23 collects and accumulates the information obtained from the wireless tag 11. The communication unit 24 transmits the information accumulated in the storage unit 23 to the center server 30.

Here, a case is described that the reader 20 has an interference preventing function. In this case, radio wave can be emitted and received at a high sensibility by a function such as diversity or the like. The diversity is a technique in which a signal received by an antenna of good condition of radio wave is preferentially used among same radio signals received by a plurality of antennas. For example, by arranging two or more reader/writer antennas of different installation angles, deterioration in reading, which depends on a change in antenna direction resulted from the arrangement of the package, is suppressed.

Also, by storing the inclusion managing device 10 on the reader/writer antenna or by using stacked RF-ID antenna, it is realized that the reader 20 periodically detects the wireless tag 11. When not detecting the wireless tag 11 for a predetermined time or a number of times, the reader 20 judges that the inclusion managing device 10 is removed. Conversely, when detecting the wireless tag 11 for a predetermined time or a number of times after the end of state in which the wireless tag 11 cannot be detected, the reader 20 judges that the inclusion managing device is returned.

Or, the reader/writer antennas are arranged at a plurality of positions so that the reader 20 detects the migration of the inclusion managing device 10. For example, the reader/writer antennas are arranged at an inlet and a bottom of a medicine cabinet for storing the reader/writer antenna. That is, the medicine cabinet serves as the reader 20. The reader 20 judges remove or return of the inclusion managing device 10 by referring to the times when the respective reader/writer antennas read the wireless tag 11.

By the way, when the reader 20 is installed in a box, a cabinet, a room and the like, it is preferred that the reader 20 is configured to link with a function or apparatus for detecting the opening/closing of a cover or a door and configured to detect remove or return of the inclusion managing device 10 only when the cover or the door is opened or closed. Because it is considered that the inclusion managing device 10 cannot be removed or returned without open or close of the cover or the door.

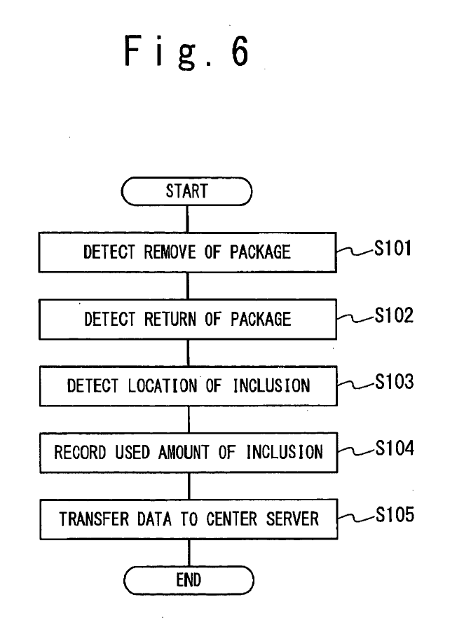

Referring to FIG. 6, in the inclusion managing system according to the present invention, operations in a case of managing a state of use of the inclusion will be described below.

### (1) Step S101

The reader 20 detects that the inclusion managing device 10 (package) is removed. That is, the movement of the inclusion managing device 10 (package) is detected. When the inclusion managing device 10 (package) is removed, the remove of the inclusion managing device 10 (package) is detected based on approach or contact between the inclusion managing device 10 (package) and the reader 20. Or, the reader 20 may be configured to periodically detect the wireless tag 11 of the inclusion managing device 10 (package) and to judge that the inclusion managing device 10 (package) moves at a time after which the wireless tag 11 is undetectable.

### (2) Step S102

The reader 20 detects that the inclusion managing device 10 (package) is returned. That is, the store of the inclusion managing device 10 (package) is detected. When the inclusion managing device 10 (package) is returned, the return of the inclusion managing device 10 (package) is detected based on approach or contact between the inclusion managing device 10 (package) and the reader 20. Or, the reader 20 may be configured to periodically detect the wireless tag 11 of the inclusion managing device 10 (package) and to judge that the inclusion managing device 10 (package) is returned at a time after which the wireless tag 11 is detectable. In this case, the reader 20 judges the return of the inclusion managing device 10 (package) when the wireless tag 11 is detected for a predetermined time or a predetermined number of times after the wireless tag 11 becomes detectable.

### (3) Step S103

When detecting the return of the inclusion managing device 10 (package), the reader 20 communicates with the wireless tag 11 of the inclusion managing device 10 (package), obtains information including the break of the antenna 12, which is stored in the wireless tag 11, and detects locations of all the inclusions packed in the inclusion managing device 10. That is, the reader 20 detects the locations of the used inclusions and a number of the used inclusions.

### (4) Step S104

The reader 20 records the used amount of the inclusions packed in the inclusion managing device 10 (package). The reader 20 may store the information in a storage medium such as a memory card or an external storage device.

### (5) Step S105

The reader 20 transfers information including a state of use of the inclusions to the center server 30. Or, the reader 20 may enables data migration by directly connecting a storage medium such as memory card or an external storage device, which stores the information including the state of use of the inclusions, to the center server 30.

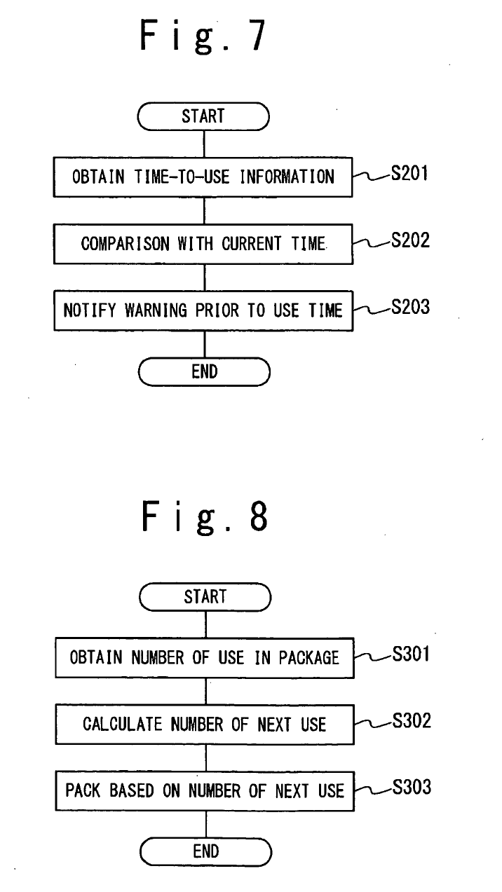

Referring to FIG. 7, operations in a case of assisting the use of inclusion will be described below.

### (1) Step S201

The reader 20 obtains time-to-use information from the wireless tag 11 of the inclusion managing device 10 (package). By the way, the reader 20 may search, as the time-to-use information, time-to-use information corresponding to respective inclusion managing device 10 (package) or inclusion, which is managed in the reader 20, based on an individual ID of the inclusion managing device 10 or the inclusion.

### (2) Step S202

The reader 20 compares the time-to-use information and a current time. Here, the reader 20 is not limited to check whether or not the time-to-use information and the current time agree with each other, and may check whether or not the current time is earlier than the time indicated by the time-to-use information by a predetermined time (for example, five minutes).

### (3) Step S203

The reader 20 notifies the user (for example, the patient) of a warning prior to the time-to-use. That is, the reader 20 generates a warning sound or displays a warning screen, when the current time is little earlier (for example, five minutes earlier) than the time indicated by the time-to-use information. Or, the reader 20 continues to display a time to use the inclusion for the next time (for example, six hours after the last remove of the inclusion) on a screen until the time agrees with the current time.

Also, referring to FIG. 8, operations in a case of calculating a number of inclusions to be used in the next time will be described below. By the way, the next time in this case includes not only the immediately after but also after the next time (future). That is, the number of inclusions to be used in the next time indicates a number of inclusions to be used in the future.

### (1) Step S301

The center server 30 obtains used-number information, which indicates a number of the used inclusions, from the wireless tag 11 of the inclusion managing device 10 (package) through the reader 20.

### (2) Step S302

The center server 30 generates use history information by summarizing the used-number information and calculates a number of inclusions to be used in the future from a number of remaining inclusions based on the use history information. Or, the center server 30 checks whether or not the use history information indicates a number of inclusions which are used based on normal use. In a case of a number other than the number of inclusions which are used based on normal use, the center server 30 sets, as the number of inclusions to be used in the next time, a preferable number of inclusions to be used based on normal use. For example, when the patient takes only medicines for 10 days among medicines for 14 days provided to the patient and when the expiration date of the remaining medicines for 4 days does not lapse, the center server 30 calculates the number of inclusions to be used in the next time as a number obtained by subtracting a number of the medicines for 4 days from a number of medicines required to be provided to the patient in the future. That is, when medicines for 7 days are required to be provided in the future, the center server 30, by subtracting the number for 4 days, determines that medicines for 3 days are required to be provided.

### (3) Step S303

When the center server 30 is linked with a packing apparatus for packing inclusions in the inclusion managing device 10 (package), the center server 30 causes the packing apparatus to pack in the inclusion managing device 10 (package), inclusions a number of which corresponds to the number of inclusions to be used in the next.

Here, the center server 30 carries out the operations in the case of calculating the number of inclusions to be used in the next time. However, actually, the reader 20 may carry out those operations.

In the present invention, a linkage with an information system for medical care, health management or the like, such as electronic medical record, is further considered. For example, it is possible to use a terminal capable of checking, by using a RF-ID reader/writer, whether or not a medicine used by the patient and information obtained from the RF-ID is correct.

Next, as examples of the inclusion managing system according to the present invention, systems or services indicated in the following (1) to (10) are assumed. However, actually, the inclusion managing system is not limited to those examples.

### (1) Medicine-Taking Managing System

In a medicine-taking managing system, the medicine cabinet for storing the package has a RF-ID reader/writer function. The medicine cabinet always monitors a state of use of drug and notifies, through a network or a storage medium such as memory card, a hospital attended by the patient or the center server of medicine-taking information such as the state of use of drug. A doctor examines a future prescription based on the notified medicine-taking information. A useless re-prescription and an excessive prescription are reduced.

### (2) Treatment Supporting System and Diagnosis Supporting System

In a treatment supporting system and a diagnosis supporting system, the blood pressure gauge for measuring blood pressure values has the RF-ID reader/writer function. The blood pressure gauge notifies, through a network or a storage medium such as memory card, a hospital attended by the patient or the center server of blood pressure values measured before and after a medicine taking, together with medicine-taking information such as a state of use of drug. Based on the notified medicine-taking information and the measurement results, a doctor plans a dosage plan or treatment plan in the future, or supports a treatment and diagnosis for a patient of the same disease.

### (3) Prescription Managing System

A prescription managing system checks whether or not a proper prescription is carried out based on digitized prescription information. For example, the prescript ion managing system carries out comparison with a prescription by using a POS system (Point Of Sales system) or terminal which has the reader/writer function.

### (4) Treatment, Dosage and Health Managing System

A treatment, dosage and health managing system is linked with an electronic medical record or the like to store dosage information such that the dosage information is correlated with a disease history, hospitalization history and hospital visit history of the patient. The treatment, dosage and health managing system records an efficacy and adverse reaction which occur when the patient takes medicine. Also, the treatment, dosage and health managing system records an interaction with another medicine or food and a health state at the time of medicine-taking. Consequently, the treatment, dosage and health managing system records a health state in detail for respective individual patient for many years.

(5) Medicine Manufacturing and Quality Control System

In a medicine manufacturing and quality control system, a terminal having the reader/writer function is installed in a routing process for a checking process with respect to medicine manufacture or quality control. This medicine manufacturing and quality control system stores data outputted from the terminal in the server and supports a quality check.

(6) Inventory and Distribution Management System

An inventory and distribution management system collectively manages a distribution amount at a carrying-out from a medicine maker or at a carrying-in into a hospital or a pharmacy. Also, the medicine manufacturing and quality control system suitably manages inventory amount in the pharmacy to carryout an inventory adjustment, or enables an inventory linkage with another pharmacy through the Internet or the like.

(7) Account Linkage System

An account linkage system carries out comparison with a prescription by using the POS system, terminal or the like having the reader/writer function at an accounting in a hospital or a pharmacy.

(8) Entrance/Exit Linkage System

An entrance/exit linkage system installs a gate or large antenna in an entrance/exit of a hospital or pharmacy to manage an entry/exit of the patient who possesses the drug.

(9) Adverse Reaction Information Managing System

An adverse reaction information managing system works with an adverse reaction information center to enable quick transmission of adverse reaction information.

(10) Clinical Trial Information Managing System

A clinical trial information managing system works with a clinical trial system to improve precision of information with regard to the medicine-taking information.

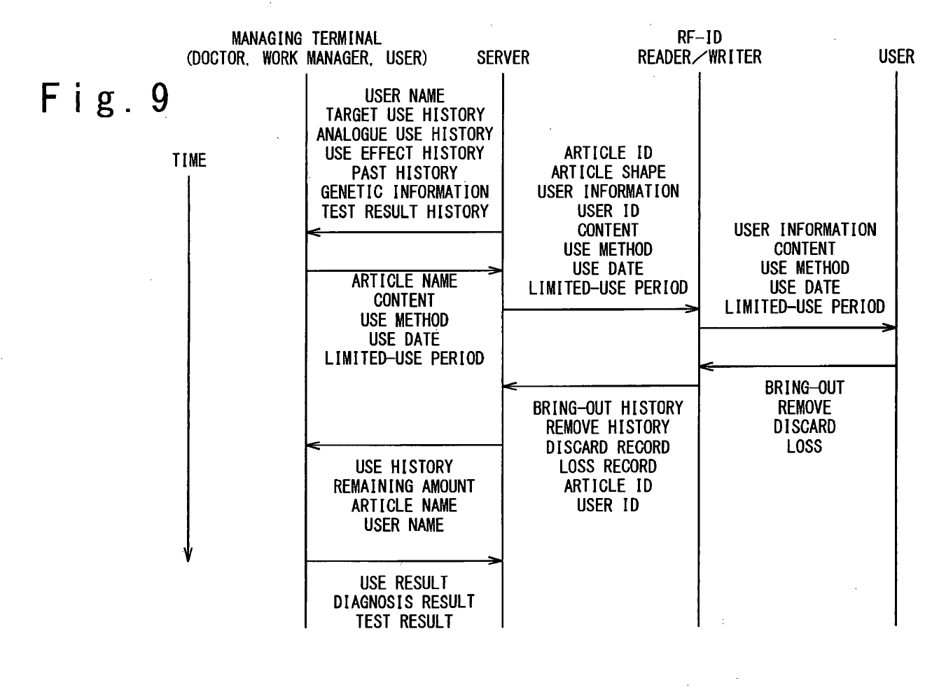

Next, with reference to FIG. 9, data flows in the inclusion managing system according to the present invention will be described below.

At first, the center server 30 transmits data to a managing terminal. The managing terminal is a communication terminal connected to the center server 30, which is used by a doctor, a work manager, a user of the inclusion or the like. As the data transmitted to the managing terminal from the center server 30, [User Name], [Target Use History], [Analogue Use History], [Use Effect History], [Past History], [Genetic Information], [Test Result History] an the like are considered. [User Name] is identification information of the user who uses the inclusion. [Target Use History] is use history information of the inclusion. [Analogue Use History] is use history information of analogue of the inclusion. For example, in a case of medicine, there are medicines which are same in ingredients even though names and manufacturers of the medicines are different. The analogue indicates an article (for example, the medicine) which is same or similar to the inclusion in ingredients or components. [Use Effect History] is history information of the effect (for example, drug effect) which is provided when the inclusion or the analogue is used. [Previous Disease History] is information with regard to diseases that the user has contracted until now. For example, [Previous Disease History] is information that has influence on the use allowance/rejection of the inclusion, number of use, and use effect. [Genetic information] is genetic information of the user. [Genetic information] indicates information with regard to diseases of close relatives, gene information used in a gene therapy and the like. [Test result history] is history information indicating results of tests executed prior to the provision of the inclusion. The test is not limited to a test performed on the inclusion and a test performed on the user himself. When the inclusion is used for a possession of the user, a test performed on the possession of the user is included.

The managing terminal transmits data to the center server 30. As the data transmitted to the center server 30 from the managing terminal, [Article Name], [Content], [Use Method], [Use Date], [Limited-Use Period] and the like are considered. [Article Name] is identification information of the inclusion. [Content] is number information of the inclusions provided to the user. [Use Method] is information indicating a using method of the inclusion. [Use Date] is information indicating timing suitable for using the inclusion. [Limited-Use Period] is information that indicates a period unsuitable for using the inclusion or an expiration date.

The center server 30 transmits data to the reader 20. Here, the reader 20 is assumed to be a RF-ID reader/writer. As the data transmitted to the reader 20 from the center server 30, [Article ID], [Article Shape], [User Information], [User ID], [Content], [Use Method], [Use Date], [Limited-Use Period] and the like are considered. [Article ID] is an identification number of the inclusion and is information corresponding to [Article Name]. [Article Shape] is information indicating shape and size of the inclusion. [User Information] is information with regard to the user and includes information individually notified to respective user from center server 30. [User ID] is an identification number of the user and is information corresponding to [User Name]. The data transmission to the reader 20 from the center server 30 is considered to be a data transmission to the outside of a facility (for example, the outside of the hospital). Thus, [Article ID] and [User ID] are used to conceal the concrete article name and user name for ensuring anonymity, thereby preventing an infringement of privacy and a leak of personal information. The other pieces of information are as mentioned above.

The reader 20 provides data to the user. For example, the reader 20 notifies the user of the data by displaying the data. Or, the data is transmitted to a communicating terminal used by the user. As the data provided to the user from the reader 20, [User Information], [Content], [Use Method], [Use Date], [Limited-Use Period] and the like are considered. These pieces of information are as mentioned above.

The user provides data to the reader 20. Here, the reader 20 reads the wireless tag 11. Also, the reader 20 may obtain the data in response to a manipulation of the user. For example, the user directly inputs the data to the reader 20 to notify the data. Or, a communicating terminal used by the user transmits the data to the reader 20. As the data provided to the reader 20 from the user, [Bring-out], [Remove], [Discard], [Loss] and the like are considered. [Bring-out] is information indicating a migration of the package. [Remove] is information indicating that the inclusion is removed from the package. That is, [Remove] indicates use information of the inclusion. [Remove] includes position information and identification information of the removed inclusion. [Discard] is information indicating that the package or the inclusion is discarded. [Loss] is information indicating that the package or the inclusion is lost. By recoding [Discard] and [Loss], it is possible to judge whether or not the user properly uses the inclusion. That is, it is possible to accurately know an actual use amount in a consumption amount of the inclusion in place of assuming [Consumption Amount of Inclusion=Actual Use Amount].

The reader 20 transmits data to the center server 30. As the data transmitted to the center server 30 from the reader 20, [Bring-out History], [Remove History], [Discard Record], [Loss Record], [Article ID], [User ID] and the like are considered. [Bring-out History] is history information based on [Bring-out] and with regard to a migration of the package within a certain period. [Remove History] is history information based on [Remove] and with regard to a remove of the inclusion within a certain period. [Discard Record] is history information based on [Discard] and with regard to a discard of the package or inclusion within a certain period. [Loss Record] is history information based on [loss] and with regard to loss of the package or inclusion within a certain period. [Article ID] is an identification number indicating the inclusion, which corresponds to one of [Remove], [Discard] and [Loss] or does not correspond to all of them, in this case. That is, [Article ID] indicates an identification number of the inclusion that is used or not used by the user. [User ID] is an identification number of the user. The data transmission to the center server 30 from the reader 20 is considered to be a data transmission to the outside. Thus, [Article ID] and [User ID] are used to conceal the concrete article name and user name for ensuring anonymity, thereby preventing an infringement of privacy and a leak of personal information. Those pieces of information may be initialized at each transmission. Also, the reader 20 may calculate [Remaining Amount] based on the recorded [Content], [Remove], [Discard] and [Loss]. The reader 20 may provide [Remaining Amount] to the user or transmit [Remaining Amount] to the center server 30. [Remaining Amount] is number information of the unused inclusions.

The center server 30 transmits data to the managing terminal. As the data transmitted to the managing terminal from the center server 30 [Use History], [Remaining Amount], [Article Name], [User Name] and the like are considered. [Use History] is history information that indicates which user uses which inclusion and the number of the used inclusions. [Use History] may include a time the inclusion is used. [Remaining Amount] is number information of the inclusions for a specified user, which have not been used. The center server 30 calculates [Remaining Amount] based on the recorded [Content], [Remove History], [Discard Record], [Loss Record] and [User ID]. However, actually, the center server 30 may receive [Remaining Amount] from the reader 20. The other pieces of information are as described above.

The managing terminal transmits data to the center server 30. As the data transmitted to the center server 30 from the managing terminal, [Use Result], [Diagnosis Result], [Test Result] and the like are considered. At this time, the managing terminal provides necessary information to the center server 30 depending on a content of the system or service. [Use Result] is information indicating results such as effects or adverse reactions caused by the use of the inclusion. [Diagnosis Result] is information indicating results of a diagnosis executed after the use of the inclusion. [Test Result] is information indicating results of a test performed on the inclusion or the user. The center server 30 reflects those pieces of information in the next provision of the inclusions to the user or subsequent provisions.

Next, a second exemplary embodiment of the present invention will be described below.

The second exemplary embodiment of the present invention uses two-dimensional barcodes instead of the antenna 12. The two-dimensional barcodes are respectively recognized by the reader. When the two-dimensional barcode is broken or erased (removed), it is impossible to read the barcode. This feature is used and the two-dimensional barcodes, in place of the antennas 12, are respectively arranged in the regions to be opened (ejection ports) of the package. The regions to be opened (ejection ports) correspond to the two-dimensional barcodes in one-to-one relation. The break or erase of the two-dimensional barcode at a specified region to be opened (ejection port) indicates the remove of the inclusion from the location. That is, the present exemplary embodiment is common to the first exemplary embodiment in that [the remove of the inclusion is detected based on the loss of the member arranged on the surface of the inclusion managing device (package)].

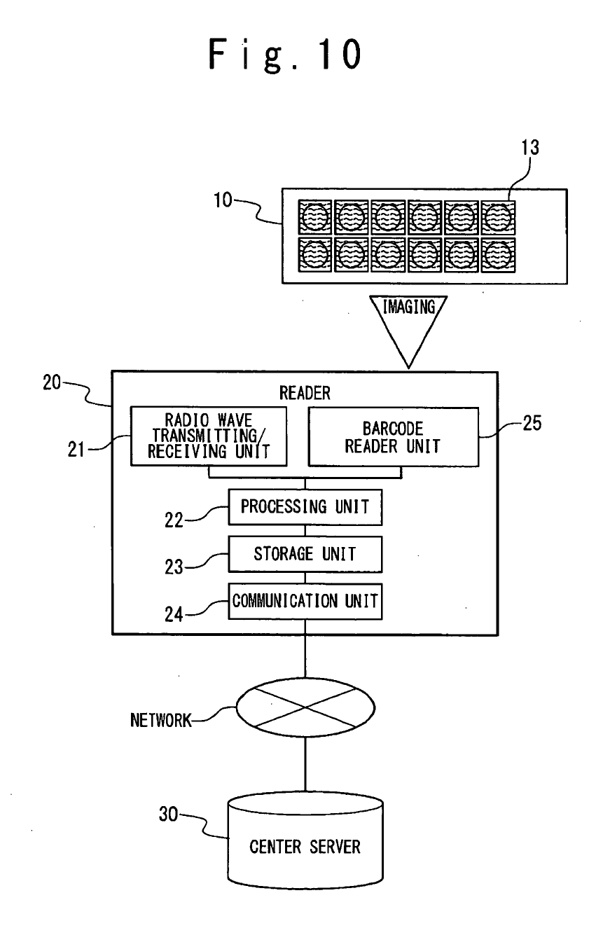

As shown in FIG. 10, in this exemplary embodiment, the inclusion managing device. 10 (package) includes the two-dimensional barcodes 13.

The two-dimensional barcode 13 is a barcode that has information along two-dimensional directions of horizontal and vertical directions in contrast with a one-dimensional barcode which has information along only horizontal direction. Here, the two-dimensional barcodes 13 are arranged, in place of the antennas 12, in the regions to be opened (ejection ports) of the inclusion managing device (package). For example, when the two-dimensional barcode 13 is displayed on the cover or lid of the inclusion managing device 10 (package), the two-dimensional barcode 13 is broken or erased at the opening. That is, the two-dimensional barcode 13 carries out the role of the antenna 12. As an example of the two-dimensional barcode, there is QR code (registered trademark). By the way, when the inclusion managing device 10 is a drug bag in which powder or the like are packed, it is considered that the two-dimensional barcode 13 is displayed on [Fastening Portion] of the drug bag or that the two-dimensional barcode 13 is displayed on the entire surface of the drug bag. However, actually, the exemplary embodiment is not limited to the foregoing examples. Then, the two-dimensional barcode 13 is only required to be displayed such that the two-dimensional barcode 13 is broken or erased at the opening of the inclusion managing device 10 (package). Since the two-dimensional barcode 13 has information by itself, the two-dimensional barcode 13 can be considered to serve as both of the wireless tag 11 and the antenna 12 in the first exemplary embodiment.

Also, the reader 20 further includes a barcode reader unit 25.

The barcode reader unit 25 reads the two-dimensional barcode 13 and notifies the processing unit 22 of an image of the read two-dimensional barcode 13. The processing unit 22 stores information, which is obtained by decoding the image of the two-dimensional barcode 13, in the storage unit 23. Here, since the storage unit 23 is the first storage unit that stores the information obtained from the two-dimensional barcode 13, the storage unit 23 can be considered to correspond to the wireless tag 11 in the first exemplary embodiment.

As the information included in the two-dimensional barcode 13, the identification information of the inclusion (individual ID) and URL (data location information) of a homepage provided by the center server 30 are considered. For example, when reading the two-dimensional barcodes 13, the reader 20 accesses the center server 30 based on the URL corresponding to the two-dimensional barcode 13 that is not broken or erased and provides the individual ID corresponding to the two-dimensional barcode 13 that is not broken or erased. Or, when reading the two-dimensional barcodes 13, the reader 20 stores the individual IDs or URLs obtained by decoding the images of the two-dimensional barcodes 13. After that, when any of the two-dimensional barcodes 13 is broken or erased to become unreadable, the reader 20 accesses the center server 30 based on a URL corresponding to a broken or erased two-dimensional barcode 13 among the stored URLs and provides an individual ID corresponding to the broken or erased two-dimensional barcode 13. At this time, it is possible to access the center server 30 based on the URL with the individual ID in which the individual ID and the URL are combined. By the way, an IP address of the center server 30 can be used instead of the URL. Also, instead of the individual ID, a number of the broken or erased two-dimensional barcodes 13 may be known. It is possible to know the number of the broken or erased two-dimensional barcodes 13 based on the maximum number of the two-dimensional barcodes 13 arranged on the inclusion managing device 10 (package) and a number of the unreadable two-dimensional barcodes 13.

Here, the remove of the inclusion is detected based on the break or erase of the two-dimensional barcode 13. Reversely, it is possible that the inclusion managing device 10 (package) is configured such that the opening of the inclusion managing device 10 (package) makes the two-dimensional barcode 13 to become readable and that the remove of the inclusion is detected by reading the two-dimensional barcode 13. For example, the inclusion managing device 10 (package) is configured such that the two-dimensional barcode 13 is displayed on the bottom or inside of the package and the remove of the cover or lid and inclusion makes the two-dimensional barcode 13 to become recognizable. The inclusion may be any of solid or liquid. It is only required to conceal the two-dimensional barcode 13 at the packed state.

By the way, when the reader 20 can read both of the wireless tag and the two-dimensional barcode, the present exemplary embodiment and the other exemplary embodiment can be executed at the same time.

Next, a third exemplary embodiment of the present invention will be described below.

Here, a packing apparatus for packing the inclusion in the inclusion managing device 10 (package) is described.

In the present exemplary embodiment, the inclusion managing system according to the present invention further includes a packing apparatus 40.

The packing apparatus 90 is a manufacturing apparatus for manufacturing the inclusion managing device 10 (package) as mentioned above. That is, the packing apparatus 40 packs the inclusions in the inclusion managing device 10 (package), and arranges the wireless tag and the antenna, or the two-dimensional barcode. The packing apparatus 40 can be configured to link with the center server 30 and the other apparatuses.

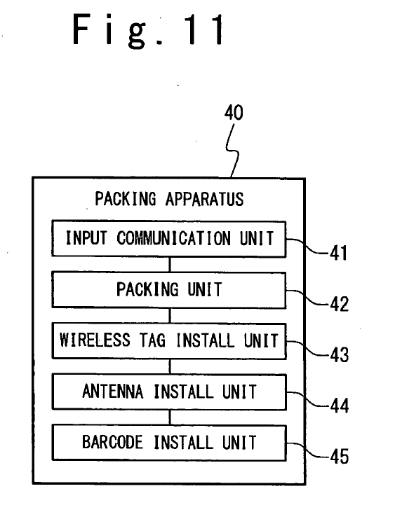

As shown in FIG. 11, the packing apparatus 40 includes an input communication unit 41, a packing unit 42, a wireless tag install unit 43, an antenna install unit 44 and a two-dimensional barcode install unit 45.

The input communication unit 41 obtains information inputted from an input device and information received from the other apparatus such as the center server 30. When the information is obtained, the antennas or the two-dimensional barcodes are arranged based on the obtained information. The packing unit 42 packs the inclusions in the inclusion managing device 10 (package). That is, the cover or lid is arranged. The wireless tag install unit 43 arranges the wireless tag 11 in the inclusion managing device 10 (package). The antenna install unit 44 arranges the antennas 12 in the inclusion managing device 10 (package). The two-dimensional barcode install unit 45 arranges the two-dimensional barcodes 13 in the inclusion managing device 10 (package).

By the way, which of the antennas 12 and the two-dimensional barcodes 13 are arranged may be selected depending on the user. For example, the antennas 12 or the two-dimensional barcodes 13 are selected based on a kind of a reader that can be used by the user. In this case, information with regard to the reader that can be used by the user is stored such that the information is correlated with the individual ID of the user.

As mentioned above, the present invention provides the device and the system for obtaining the state of ingestion or use of the inclusions such as medicines and foods. In medicine-taking, it is necessary to manage dispensed medicines in treating a disease. However, a conventional electronic medical record system or medicine trace system can record information until dispense of medicines but cannot trace and record whether or not a patient actually takes the medicines. The present invention provides a device and a system that are intended to trace and record whether or not the patient takes the medicines.

For example, when a plurality of medicines or foods are packed in one unit, since an antenna, electric circuit or the like of RF-ID is arranged for each pack, state of remove of the plurality of inclusions is managed by using one RF-ID. In the case of the antenna, by selecting the shape, the arrangement, the width, the material and the like, a mechanism is provided which can discriminate a case of break and the remove of the inclusion. When one antenna is cut by removing an inclusion, a location from which the inclusion is removed is specified by transmitting/receiving radio wave of frequency set correspondingly to an effective length of the cut antenna. Moreover, information with regard to the removed inclusion is used to calculate quantity to be used in the future.

In the foregoing description, medicines and foods are used as examples of the inclusions packed in the inclusion managing device 10 (package). However, the inclusion is not limited to those examples. Actually, the inclusions are only required to be packed in the inclusion managing device 10 (package). For example, the inclusions may be cosmetics, perfume, cleanser, fragrance agent, air freshener, seeds or berries of plant, soil, sand, samples for research such as sampled specimen and chemical substance, screws, electronic parts, small toys, assembling parts, samples of commodity to be distributed at a street or shop, or the like. Also, the inclusion managing device 10 (package) can pack things which is required to be vacuum sealed. That is, the inclusion may be any of solid, liquid or gas.

1. An inclusion managing device comprising:
a passive type wireless tag arranged on packages for packing inclusions and configured to generate a voltage through electromagnetic induction (contactless power transmission) caused by radio wave from a reader and to transmit/receive information by emitting/receiving radio wave; and
antennas arranged at regions for removing said inclusions (ejection ports) on said packages which that said antennas are broken at remove of said inclusions from said packages and configured to notify said passive type wireless tag of remove of said inclusion,
wherein gaps between said antennas and borders of said regions for removing said inclusions (ejection ports) are smaller than minimum width required to remove said inclusions.

2. The inclusion managing device according to claim 1, wherein said reader specifies, based on change in frequency corresponding to change in length of antenna caused by break, a location of an inclusion corresponding to said broken antenna.

3. The inclusion managing device according to claim 1, wherein said antennas correspond to said inclusions in one-to-one relation and are arranged independently and individually for respective inclusions packed in said packages, and
independent individual antennas respectively use different frequencies.

4. The inclusion managing device according to claim 1, wherein said antennas are arranged at connecting portions between said packages and are configured to break when said packages are separated, and
said passive type wireless tag detects, based on change in frequency corresponding to change in length of antenna caused by break, a number of connected packages.

5. The inclusion managing device according to claim 1, further comprising:
lids which are arranged to seal said regions for removing said inclusions (ejection ports) and adhere to said antennas such that said antennas are removed from said packages at opening.

6. An inclusion managing device comprising:
packages for packing inclusions; and
two-dimensional barcodes which correspond to said inclusions in one-to-one relation, include information with regard to said inclusions, are displayed to cover regions for removing said inclusions (ejection ports) on said packages and are configured to be loss at remove of said inclusions from said packages.

7. An inclusion managing device comprising:
packages for packing inclusions; and
two-dimensional barcodes which correspond to said inclusions in one-to-one relation, include information with regard to said inclusions, are displayed in said packages which that said two-dimensional barcodes are concealed by said inclusions and are configured to become recognizable when said inclusions are removed from said packages.

8-21. (canceled)

22. An inclusion managing method comprising:
notifying a passive type wireless tag on packages of remove of inclusions when antennas, which arranged at regions for removing said inclusions (ejection ports) on said packages, are broken at remove of said inclusions from said packages; and
specifying a location of an inclusion corresponding to a broken antenna based on change in frequency corresponding to change in length of antenna caused by break.

23. The inclusion managing method according to claims 22, further comprising:
communicating at respectively different frequencies with antennas which correspond to said inclusions in one-to-one relation and are arranged independently and individually for respective inclusions packed in said packages; and
specifying a location of an inclusion corresponding to a broken antenna based on differences in frequency corresponding to respective antennas.

24. The inclusion managing method according to claim 22, further comprising:
detecting said passive type wireless tag periodically;
detecting remove of said packages;
detecting return of said packages;
detecting locations of inclusions packed in said packages by communicating with said passive type wireless tag and by obtaining information stored in said passive type wireless tag when return of said packages are detected; and
recording used amount of inclusions packed in said packages.

26. The inclusion managing method according to claim 24, further comprising:
obtaining used-number information from said passive type wireless tag; and
calculating quantity to be used in a future from remaining quantity based on use history information generated by summarizing used-number information.
